(19) United States
(12) Patent Application Publication
(10) Pub. No.: US 2025/0037906 A1
(43) Pub. Date: Jan. 30, 2025

(54) CONDUCTOR DEVICE, PREFERABLY FOR LOW TEMPERATURE APPLICATIONS, AND METHOD OF MANUFACTURING THEREOF

(71) Applicant: Max-Planck-Gesellschaft zur Foerderung der Wissenschaften e.V., Muenchen (DE)

(72) Inventors: Antonio BENTO, Muenchen (DE); Lucia Canonica, Muenchen (DE); Michael Hertrich, Muenchen (DE); Federica Petricca, Muenchen (DE)

(21) Appl. No.: 18/783,683

(22) Filed: Jul. 25, 2024

(30) Foreign Application Priority Data
Jul. 28, 2023 (EP) 23188319.0

(51) Int. Cl. H01B 12/02

(52) U.S. Cl. CPC H01B 12/02

(57) ABSTRACT

A conductor device 100, preferably being configured for low temperature applications, comprises multiple conductor wires 10 being arranged along a longitudinal extension of the conductor device 100, and an electrically insulating encapsulation material 20, wherein the conductor wires 10 are encapsulated in the encapsulation material 20, so that each conductor wire 10 is covered by the encapsulation material 20 in all radial directions relative to the longitudinal extension of the conductor device 100, wherein the conductor wires 10 have electric superconductivity at an operation temperature equal to or below −196° C., and each conductor wire 10 has two longitudinal end sections 11 and a self-supporting wire section 12 therebetween. Furthermore, an electrical conductor arrangement including the conductor device and a method of manufacturing the conductor device 100 are described.

### FIELD OF THE INVENTION

The invention relates to a conductor device, in particular a cable including multiple wires, preferably being adapted for low temperature applications. Furthermore, the invention relates to a method of manufacturing the conductor device. Applications of the invention are available in the fields of e.g., measuring techniques, signal processing and/or cryo-techniques.

### PRIOR ART

In the present specification, reference is made to the following prior art illustrating technical background of the invention and related techniques:
[1] US 2019/0341174 A1;
[2] US 2018/0294401 A1; and
[3] A. B. Walter et al. “Laminated NbTi-on-Kapton Microstrip Cables for Flexible Sub-Kelvin RF Electronics” in IEEE Transactions on Applied Superconductivity, vol. 28, No. 1, January 2018.

It is generally known that a broad range of physical or chemical processes, like measurements or processes of electrical engineering, are executed at low operation temperatures, in particular at temperatures equal to or below −195.8° C. or −269° C. (respectively liquid Nitrogen and liquid Helium temperatures). For monitoring and/or controlling purposes, providing a plurality of electrically conducting connections between a low temperature range and a surrounding with normal conditions, e.g., room temperature, may be required.

As an example, the CRESST dark matter searching experiment (www.cresst.de) includes a plurality of sensors which are operated at cryogenic temperature (about 15 mK) in a superconducting condition (superconducting sensors), like e.g., Transition Edge Sensors, TES. The readout of the superconducting sensors with a data recorder at normal temperature (room temperature, about 20° C.) requires a plurality of signal connections between the sensors and the data recorder. For providing a low-impedance readout (with an impedance in the mOhm range), wires are needed which are in a superconducting condition at low temperature (superconducting wires), so that no or neglectable resistance is added in series in the measuring process.

In a current setup of the CRESST experiment, superconducting NbTi wires are practically used which comprise woven cables, including a mesh isolation with a superconducting wire inside, and which typically are assembled in ribbon and have a length of about 2.5 m. These wires have various disadvantages resulting from their thickness and the space required for arranging the wires. Furthermore, the superconducting wires do not have well defined positions, so that shielding of the wires is difficult, non-reproducible crosstalk may occur between different wires and connecting the wires to hardware components is difficult and time consuming. These problems are even increased with a forthcoming upgrade of the CRESST experiment, which will be operated with a number of 66 to 300 readout channels. This implies 5 times more wires in the experimental setup.

The material of superconducting wires usually is NbTi, which has advantages in terms of a relatively high critical temperature of 9 K. However, using niobium based wires also may cause difficulties, because NbTi is difficult to machine or solder or to connecting the wire e.g., to a printed circuit board (PCB). Furthermore, individual wires usually have a circular cross-section, so that a limited pressing contact may be obtained.

Superconducting lines created by depositing a thin film of an electrically superconducting material on an isolating carrier and covering the thin film superconducting material are disclosed in e.g., [1] to [3]. According to [3], multiple lines are commonly created on a carrier for providing a cable. These techniques may have advantages in terms of using a thinner conductor and providing lines at well-defined positions. However, it cannot be used in practical applications as it does not match to existing cryogenic infrastructure, has reduced stability in practical use and/or it is limited to connector lengths of some cm.

### OBJECTIVE OF THE INVENTION

The objective of the invention is to provide an improved conductor device, preferably being adapted for low temperature applications, and/or an improved method of manufacturing the conductor device, which avoid disadvantages of conventional techniques. In particular, the conductor device is to be capable of requiring less space, providing a superconducting path within a low temperature environment or between a low temperature environment and a surrounding at normal temperature, facilitating shielding against electromagnetic fields, reducing cross-talk between conductors, providing defined conductor positions, facilitating connecting the conductor device with hardware components, like a PCB, having improved mechanical stability and/or providing increased connector lengths. Furthermore, the method of manufacturing the conductor device in particular is to be characterized by simplified process steps and/or improved variability in terms of number and lengths of connectors.

### BRIEF SUMMARY OF THE INVENTION

These objectives are correspondingly solved by a conductor device and a method of manufacturing the conductor device of the invention.

According to first general aspect of the invention, the above objective is solved by a conductor device, preferably being adapted for low temperature applications, comprising multiple conductor wires being arranged along a longitudinal extension of the conductor device, and an electrically insulating encapsulation material, wherein the conductor wires are encapsulated in the encapsulation material, so that each conductor wire is covered by the encapsulation material in all radial directions relative to the longitudinal extension of the conductor device, wherein the conductor wires have electric superconductivity at an operation temperature equal to or below −196° C. (about 77 K), preferably equal to or below −269° C. (about 4 K), and each conductor wire has two longitudinal end sections and a self-supporting wire section therebetween. Preferably, the self-supporting wire section extends along the whole length between the end sections, and particularly preferred the end sections are self-supporting as well. Accordingly, the superconducting wires preferably are continuously self-supporting along the whole length thereof.

According to second general aspect of the invention, the above objective is solved by a method of manufacturing the conductor device according to the first general aspect of the invention or an embodiment thereof, comprising the steps of providing the superconducting conductor wires, and encapsulating the conductor wires in the encapsulation material by extrusion with an extruder apparatus. Preferably, providing the superconducting conductor wires may comprise arranging the conductor wires in parallel and side by side, preferably at a predetermined pinch, so that the conductor device is extruded with a flat cable shape. With a further preferred embodiment of the manufacturing method, flattening at least one longitudinal end section of at least one of the conductor wires may be provided.

Advantageously, the conductor device of the invention comprises a cable including multiple (at least two) self-supporting conductor wires with electric superconductivity at the operation temperature (also called superconducting wires in the following). The conductor device guarantees a superconducting path between components, in particular electrical devices, within a low temperature environment and/or a sectional superconducting path between a component, in particular electrical device, in a low temperature environment and a component, in particular electrical device, in a normal temperature environment. The conductor device also can be employed exclusively within a normal temperature environment. The superconducting wires are encapsulated in the encapsulation material along the longitudinal extension of the conductor device. The conductor wires are aligned along the longitudinal extension of the conductor device and also in directions perpendicular to the longitudinal extension, so that the positions of the conductor wires are well defined and adapted for an efficient connection with hardware components, like a PCB, a sensor and/or a cable connector between multiple conductor devices.

An electrical conductor arrangement comprising a first electrical device and a second electrical device and the conductor device according to the first general aspect of the invention or an embodiment thereof, being electrically connected between the first and second electrical devices, is considered as a further subject of the invention.

Preferably, a continuous encapsulation is provided along the longitudinal extension of the conductor device, covering the whole length of the superconducting wire or particularly preferred providing at least one end of the superconducting wires exposed. Advantageously, a compact arrangement of the conductor wires is obtained by the encapsulation. Furthermore, as the relative positions of the conductor wires within the conductor device are fixed along the longitudinal extension of the conductor device, a crosstalk between the superconducting wires is excluded or suppressed to a neglectable manner or set to a fixed, reproducible amount (thus allowing a crosstalk correction of currents through the conductor device).

Due to the fixed mutual arrangement of the conductor wires within the cable, shielding of the conductor device against electromagnetic fields is facilitated and connecting the conductor wires with hardware components is improved. In particular, the cable design of the inventive conductor device facilitates a simultaneous connection of end sections at a common end of the conductor device with a hardware component by a common coupling step. As a further advantage, employing self-supporting material provides an improved mechanical stability of the conductor device, allows increased connector lengths and facilitates manufacturing of the cable.

The inventive design of the conductor device is particularly suitable for allowing an easy manufacturing process by encapsulating available superconducting wires. The inventors have found that superconducting wires have mechanical characteristics, in particular flexibility and/or tear strength, which allow an extrusion with an extruder apparatus. Extrusion is obtained without any deteriorating impact on the integrity of the superconducting wires. As a further advantage of the manufacturing method, encapsulation simply can be adapted to a particular number of superconducting wires to be integrated within one common cable and/or to a particular length of the conductor device to be provided.

The conductor device has a longitudinal extension, i.e. the length between the end sections is larger than a cross-sectional dimension of the conductor device. The conductor device may be arranged with a straight (straight longitudinal extension) or curved (curved longitudinal extension) shape. The encapsulation material may be rigid or flexible (bendable) along the longitudinal extension at normal temperature. Furthermore, the encapsulation material may be rigid or flexible in directions deviating from the longitudinal extension at normal temperature. Even with bent encapsulation material, the relative positions of the superconducting wires within the conductor device are sufficiently fixed for suppressing the crosstalk.

In contrast to the prior art techniques, e.g., of [1] to [3], the inventive conductor device includes wires instead of thin film lines. While a thin film line can exist only on a substrate and has no stability without the substrate, the superconducting wires have stability even without a carrier substrate. The superconducting wires are self-supporting, i.e., they are configured (in particular their thickness) such that the superconducting wires keep mechanical integrity and conductor function without further external elements, in particular without the encapsulation material, for load absorption during manufacturing and applying the conductor device, e.g., during extrusion and when arranged between components to be connected, in particular both in a low temperature and a normal temperature environment. In other words, the superconducting wires are configured in such a way that all loads occurring during manufacturing and application are absorbed in the superconducting wires.

Material properties of the superconducting wires, in particular their thickness, can be selected for providing the self-supporting characteristic by tests or numerical simulations. The inventors have found that the thickness, e.g., cross section dimension, of each superconducting wire is within a range from 0.005 mm² to 0.1 mm², in particular from 0.012 mm² to 0.07 mm². The length of the superconducting wires preferably is at least 10 cm, particularly preferred at least 1 m, like 2.5 m or more. Advantageously, long cables with a length of some meter can be provided. In contrast to the prior art techniques, e.g., of [1] to [3], the superconducting wires have a certain cross section area, which gives the wire the stability, and this cross section area is much bigger than the minimum cross section dimension, like thickness, of a line.

The encapsulation material preferably may be a polymer material, like a polymer selected from the group of polymers comprising polyimide and polyester. Advantageously, polymers have advantages for manufacturing the conductor device and for providing electrical insulation in a broad range of operation temperatures.

Preferably, the conductor wires are separated from each other by the encapsulation material by a predetermined distance (pitch), e.g., in a range from 0.3 mm to 1 mm.

According to a preferred embodiment of the invention (flat cable embodiment), the conductor wires may be arranged side by side so that the conductor device has a flat cable shape. With a straight arrangement of the conductor device, the superconducting wires may be arranged in a plane. Advantageously, the conductor device can be manufactured with a thickness (perpendicular to the longitudinal extension) below 0.5 mm, or even below 0.2 mm. Another advantage of the flat cable configuration is to allow a multiwire connection with a hardware component at once, in one single step.

As a further advantage, the conductor device with the flat cable shape allows stackability, i.e., it can be arranged a stack of cables with low space consumption. Accordingly, a stacked arrangement of conductor devices according to the first general aspect of the invention or an embodiment thereof, in particular a stacked arrangement of conductor devices according to the flat cable embodiment is considered as an independent subject of the invention. The lengths of the conductor devices along the wire sections may be coupled, e.g. by employing an adhering material, like a glue, and/or by a bonding technique.

According to a further preferred embodiment of the invention, at least one of the conductor wires may have a flattened shape at at least one longitudinal end section thereof (flattened end section, flat contacts), wherein the flattened shape of the at least one conductor wire extends a predetermined length in its longitudinal direction. Particularly preferred, all superconducting wires may have flattened end sections at one common end of the conductor device or at both ends of the conductor device. The predetermined length of the flattened end section may be at least 2 mm, e.g. 3 mm, and at most 5 mm.

Preferably, flattened end sections at a common end of the conductor device are aligned such that the flattened end sections extend in a common plane. With the flat cable embodiment, the flattened end sections may be aligned with the plane of the flat cable.

Advantageously, the flat cable embodiment allows employing round wires that are easily available in the market, and use them in the flat cable arrangement and further providing flat contacts. The particular advantage of the flat cable configuration is to allow a multiwire connection at once, in one single step.

The term “end section” refers to the end of a superconducting wire. Depending on application, the end section may have the same configuration like the wire section between the ends of the superconducting wire, or the end section may have a configuration adapted for an electrical connecting function. In other words, the conductor device may be provided to the user as a cable of encapsulated conductor wires without a special connector configuration at the cable ends. The conductor device can be adapted for the particular connecting task by the user. Alternatively, the conductor device may be provided to the user as a cable with the end sections adapted for the electrical connecting function. The end section of each conductor wire preferably may have a length selected for the particular connecting function, e.g., for a plug connection and/or a clamp connection.

According to a preferred embodiment of the invention, at least one of the longitudinal end sections of at least one of the conductor wires may be exposed. Particularly preferred, the exposed end section(s) may be exposed on one side of the conductor wire end section(s) (exposed side) facing to one side of the conductor device (also called upper side of the conductor device). Furthermore, particularly preferred, the opposite side of the exposed conductor wire end section(s) facing to an opposite side of the conductor device (also called lower side of the conductor device) may be covered by the encapsulation material. Advantageously, the exposed end section provides a contact area adapted for a direct electrical contact with a hardware component. Particularly preferred, the exposed end section may be exposed along the predetermined length of the end section, e.g. along the flattened shape of the longitudinal end section.

A further advantage of the invention results from the possibility of using different cross-section shapes of the superconducting wires. Preferably, at least one of the conductor wires may have one of a circular cross-section shape and a flattened cross-sectional shape along its longitudinal length, in particular along the whole length of the wire section between the end sections. Particularly preferred, all superconducting wires may have the same shape.

The circular cross-section shape (round wire shape) has a particular advantage in terms of reduced capacitive coupling between the superconducting wires. Preferably, conductor wires with the circular cross-section shape along the wire section in combination with flat shape end sections may be provided, so that the less interference along lengths is combined with better connection at end sections.

The flattened cross-section shape (flat wire shape) has a particular advantage in terms of improved shielding capability of the conductor device. Furthermore, conductor wires with the flat wire shape along the wire section in combination with flat shape end sections have advantages for manufacturing the conductor device based on a superconducting wire completely pre-flattened before extrusion with the encapsulation material.

According to a further particularly advantageous embodiment of the invention, a shielding device may be arranged for shielding the conductor wires against electromagnetic fields, wherein the shielding device preferably is a shielding layer attached to the encapsulation material. The shielding layer may be directly attached to the encapsulation material. Alternatively, the shielding layer may be attached to the encapsulation material via an intermediate layer portion. The shielding layer may be coupled with ground potential or another reference potential. The shielding layer may be attached to one, multiple or all sides of the conductor device.

The shielding layer extends along the length of the conductor device. Preferably, the shielding layer may extend along the whole longitudinal extension of the conductor device, in particular overlapping with the end sections of the conductor wires. Advantageously, the shielding of the conductor wires up to the end sections thereof may be improved with this embodiment.

In particular, with the conductor device having the flat cable shape and at least one exposed end section, the shielding layer may be attached at least to the side of the encapsulation material that is opposite to the exposed side of the conductor wires at the end section(s). Accordingly, the shielding layer may be arranged on the lower side of the conductor device. Advantageously, one single shielding layer may be provided on one side of the conductor device, e.g. having the flat cable shape, commonly shielding all of the conductor wires along the whole length thereof.

Preferably, the shielding device may comprise a layer of a shielding material showing electric superconductivity at the operation temperature. With preferred examples, the shielding device may be made of aluminum, niobium, or other superconducting material.

According to a further preferred embodiment of the invention, a cable interface termination may be arranged at at least one end of the conductor device, preferably at both ends of the conductor device, wherein the cable interface termination comprises a solid carrier substrate supporting the conductor wires, in particular the end sections thereof, at the cable interface termination, wherein the end sections of the conductor wires at the cable interface termination are exposed at the same end. Advantageously, the cable interface termination facilitates connecting the conductor device with a hardware component.

Particularly preferred, the carrier substrate may have a lateral extension larger than a width of the encapsulation material encapsulating the conductor lines. Accordingly, the solid carrier substrate preferably may have an indentation in its lateral direction perpendicular to the longitudinal extension of the conductor device.

Advantageously, further characteristics of the conductor wires can be selected in dependency on the particular application of the invention. Preferably, the conductor wires can be made of NbTi. Alternatively, other materials can be used, like e.g., Nb₃Sn. Preferably, at least 4 conductor lines are included in the conductor device. For practical applications, the layout of the cable is particularly suitable when a large number of channels is involved, typically 8 or more wires.

### BRIEF DESCRIPTION OF THE DRAWINGS

Further details and advantages of the invention are described in the following with reference to the attached drawings, which show in:

FIG. 1: a schematic top view of a conductor device according to preferred embodiments of the invention;

FIG. 2: a schematic cross sectional view of the conductor device of FIG. 1 along line II-II;

FIG. 3: a schematic cross sectional view of the conductor device of FIG. 1 along line III-Ill;

FIG. 4: a schematic illustration of a method of manufacturing the conductor device to preferred embodiments of the invention;

FIG. 5: a schematic top view of a conductor device according to alternative embodiments of the invention;

FIG. 6: a schematic cross sectional view of the conductor device of FIG. 5 along line VI-VI; and

FIG. 7: a schematic illustration of an electrical conductor arrangement according to embodiments of the invention.

### PREFERRED EMBODIMENTS OF THE INVENTION

Features of preferred embodiments of the invention are described in the following with exemplary reference to flat cable embodiments of the conductor device, having 8 conductor wires and a cable interface termination adapted for a clamping connection with hardware components. It is emphasized that the invention is not restricted to the described embodiments, but can be realized with modified characteristics, e.g., with regard to the geometrical features, the number and/or arrangement of the superconducting wires, the functionality of the end sections, and/or the materials. Details of preparing materials for manufacturing the conductor device, like e.g., the manufacturing of superconducting wires or the preparation of a polymer for extrusion, are not described as they are known per se from prior art. The drawings are schematic illustrations not to scale. The drawings show portions of the conductor device only, which has a length substantially larger than a lateral width of the conductor device in practice.

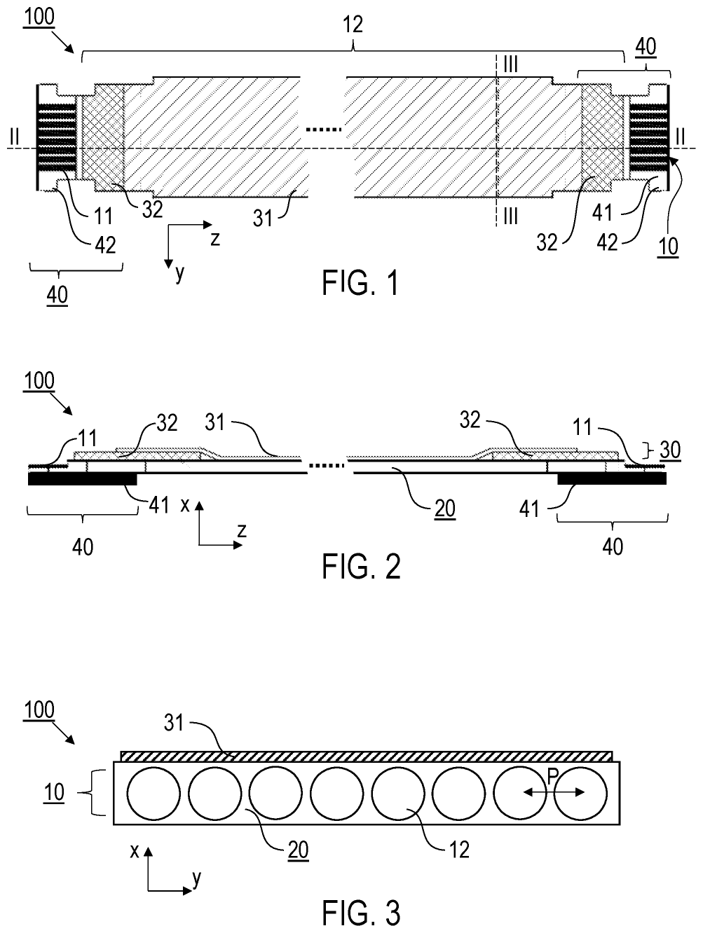

FIGS. 1, 2 and 3 show a top view and cross-sectional side views of a conductor device 100 with a plurality of e.g., 8 conductor wires 10, an electrically insulating encapsulation material 20, a shielding device 30 and cable interface terminations 40. The conductor device 100 has a longitudinal extension (z-direction), wherein, with a straight arrangement of the conductor device 100, the conductor wires 10 are arranged straight and in parallel in a common plane (y-z-plane). The length of the conductor device 100 is e.g., at least 0.5 m or 1 m or more, and the lateral width (y direction) is e.g., at least 5 cm or 8 cm or more.

The conductor wires 10 extend along the whole lengths of the conductor device 100. End sections 11 of the conductor wires 10 provide exposed contact areas. The lengths between the end sections 11 (wire sections 12 of the conductor wires 10) are arranged side by side with a pitch P in a range of e.g., 0.5 mm to 1 mm. Along the wire sections 12, the conductor wires 10 have a circular cross section (see FIG. 3) with a diameter providing self-supporting characteristic, e.g., at least 0.1 mm, e.g. 0.2 mm or more, in particular up to 1 mm or even more. At the end sections 11, the conductor wires 10 are flattened to a thickness of e.g., 0.2 mm.

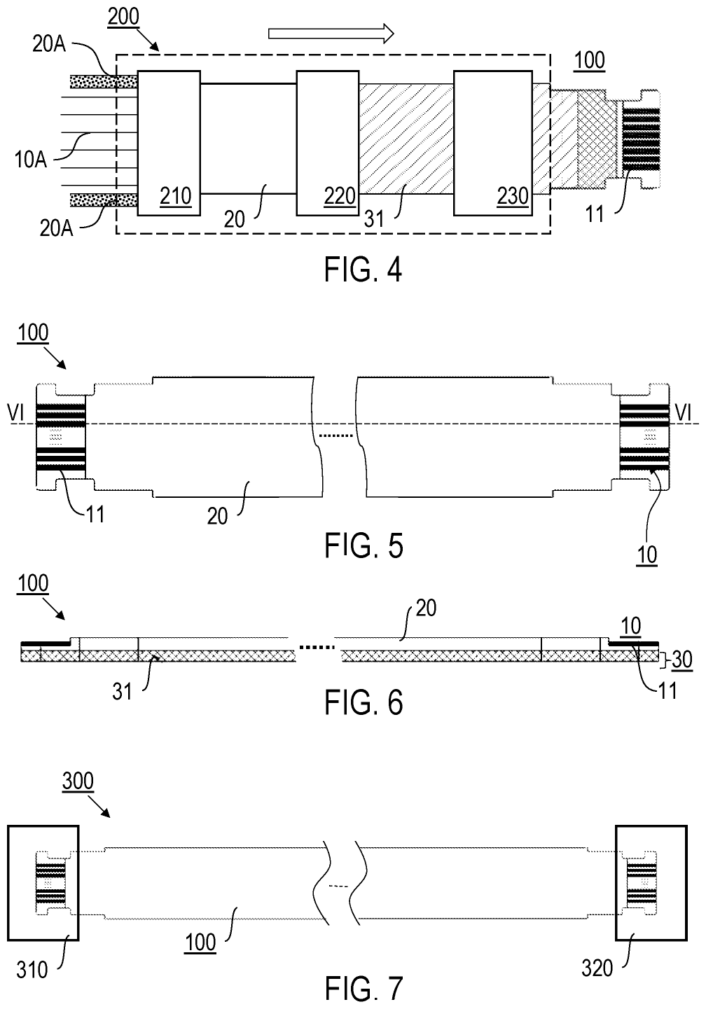

Except of the end sections 11, conductor wires 10 are fully covered by the encapsulation material 20 in all directions deviating from the z-direction. The encapsulation material 20 is formed by extrusion as described below with reference to FIG. 4. Preferably, the encapsulation material 20 comprises polyimide polymer, e.g. FEP (Fluorinated Ethylene Propylene) or ETFE (Ethylene tetrafluoroethylene), with a thickness of covering the conductor wires 10 of e.g., 0.1 mm or more. Accordingly, the whole thickness of the conductor device 100 along the wire section 12 is about 0.3 mm.

The shielding device 30 comprises a shielding layer 31 covering one side (upper side) of the conductor device 100, in particular the length and width of the wire sections 12 thereof. The shielding layer 31 is made of e.g., aluminum with a thickness of 0.03 mm. For reliable connecting the shielding layer 31 with a reference potential, like ground potential, the shielding device 30 further comprises contact tapes 32 arranged between the encapsulation material 20 and the shielding layer 31 and being partially exposed from the shielding layer 31 at the cable interface terminations 40. The contact tapes 32 have a thickness greater than the shielding layer 31, e.g., 0.5 mm. Preferably, the contact tapes 32 comprise the same material like the shielding layer 31, e.g., aluminum.

Each of the cable interface terminations 40 at the ends of the conductor device 100 comprises a solid carrier substrate 41 supporting the end sections 11 of the conductor wires 10 and slightly overlapping with the encapsulated wire sections 12 of the conductor wires 10 (see FIG. 2). The carrier substrate 41 have lateral extensions larger than the lateral width of the encapsulation material 20 so that lateral indentation 42 are formed. With the lateral indentations 42, the cable interface terminations 40 can be fixed to a hardware component to which the conductor device 100 is coupled in operation. The solid carrier substrates 41 comprise reinforcement tapes, made of e.g., polyester with a thickness of 0.2 mm. The longitudinal length of each of the cable interface terminations is e.g., at least 4 cm and in particular up to 8 cm or more.

The conductor device 100 is manufactured with a manufacturing apparatus 200 illustrated in FIG. 4. The manufacturing apparatus 200 in particular comprises an extruder apparatus 210, a lamination apparatus 220 and a mounting apparatus 230. The extruder apparatus 210 is arranged as a first station of the manufacturing method (from left to right in FIG. 4) for encapsulating the superconducting wires in the encapsulation material 20. Precursor materials, including conductor wires 10A and polyimide polymer 20A are fed to the extruder apparatus 210, which creates the composite of the conductor wires embedded in the encapsulation material 20.

Subsequently, the shielding device 30 with the shielding layer 31 and the contact tapes 32 (see FIG. 1) is applied with the lamination apparatus 220, e.g. by laminating a thinner aluminum foil for the shielding layer 31 and a thicker aluminum foil for the contact tapes 32 (see FIG. 1). The lamination apparatus 220 is adapted for a controlled lamination such that predetermined lengths of the shielding device are applied.

The mounting apparatus 230 generally refers to an equipment being adapted for providing the final configuration of the conductor device 100, in particular by cutting the product with a predetermined length and applying the cable interface terminations 40. Preferably, the mounting apparatus 230 is adapted for flattening the end sections 11 of the conductor wires, e.g. with a pressing tool.

It is emphasized that the manufacturing apparatus 200 of FIG. 4 represents a schematic illustration of main components arranged for manufacturing the conductor device 100. In practice, the stations 210, 220 and 230 can be combined in a common machine and/or further equipment can be provided for monitoring and/or controlling the manufacturing method.

FIGS. 5 and 6 show a top view and a cross-sectional side view of a conductor device 100 according to alternative embodiments of the invention. The conductor device 100 generally is configured as described above with reference to FIGS. 1 to 3, in particular with a plurality of e.g., 6 or more conductor wires 10 and an electrically insulating encapsulation material 20.

Deviating from the embodiments of FIGS. 1 to 3, the shielding device 30 comprises a shielding layer 31 being arranged on a lower side of the conductor device 100 and extending along the length, preferably the whole length, of the conductor device 100, in particular also along the end sections 11 of the conductor wires 10. Preferably, the shielding layer 31 may be directly coupled along the whole length thereof with the encapsulation material 20. The shielding layer 31 is arranged opposite to the exposed sides of the end sections 11, and it overlaps with the whole lengths of the end sections 11 of the conductor wires 10. Despite of this difference, the shielding layer 31 may be provided as described above. The conductor device 100 of FIGS. 5 and 6 may be manufactured with the manufacturing apparatus 200 of FIG. 4 adapted to the shielding configuration of FIGS. 5 and 6.

Optionally, as shown in FIG. 6, the solid carrier substrate and/or the contact tapes, as described with reference to the embodiments of FIGS. 1 to 3, may be omitted with the embodiments of FIGS. 5 and 6.

An electrical conductor arrangement 300, which is a further subject of the invention, is schematically shown in FIG. 7. The electrical conductor arrangement 300 comprises a first electrical device 310 and a second electrical device 320, which are electrically connected via the conductor device 100 according to an embodiment of the invention. At least one of the first and second electrical devices 310, 320 and at least a section of the conductor device 100 are arranged at an operation temperature equal to or below −196° C. As an example, in particular with an application in the CRESST dark matter searching experiment, the first and second electrical devices 310, 320 may comprise e.g. sensors and data recorders, respectively.

In summary, the inventive conductor device 100 in particular provides a topology that allows an easy manufacturing of long superconducting flat cables with multiwires and combines a superconducting shield against electro-magnetic interference (EMI) in an arrangement of low complexity. The conductor device 100 is especially adequate for low temperature applications where a large number of signal channels is employed. Contrary to available commercial woven cables, the invention has been demonstrated to provide better performance against crosstalk than the woven cables. This advantage is particularly important, when used in a stacked arrangement, which is exactly what is preferred when a large number of signal channels are employed.

The features of the invention disclosed in the above description, the drawings and the claims can be of significance individually, in combination or sub-combination for the implementation of the invention in its different embodiments.

What is claimed is:

1. A conductor device comprising:
multiple conductor wires being arranged along a longitudinal extension of the conductor device, and
an electrically insulating encapsulation material, wherein the conductor wires are encapsulated in the electrically insulating encapsulation material, so that each of the conductor wires is covered by the electrically insulating encapsulation material in all radial directions relative to the longitudinal extension of the conductor device, wherein
the conductor wires have electric superconductivity at an operation temperature equal to or below −196° C., and
each of the conductor wires has two longitudinal end sections and a self-supporting wire section therebetween.

2. The conductor device according to claim 1, wherein
the conductor wires are arranged side-by-side so that the conductor device has a flat cable shape.

3. The conductor device according to claim 1, wherein
at least one of the conductor wires has a flattened shape at at least one longitudinal end section thereof, wherein the flattened shape of the at least one conductor wire extends a predetermined length in its longitudinal direction.

4. The conductor device according to claim 1, wherein
at least one of the longitudinal end sections of at least one of the conductor wires is exposed.

5. The conductor device according to claim 1, wherein
at least one of the conductor wires has one of a circular cross-section shape and a flattened cross-sectional shape along its longitudinal length.

6. The conductor device according to claim 1, further comprising
a shielding device being arranged for shielding the conductor wires against electromagnetic fields, wherein the shielding device comprises a shielding layer attached to the electrically insulating encapsulation material.

7. The conductor device according to claim 6, wherein
the shielding layer extends along an entirety of the longitudinal extension of the conductor device.

8. The conductor device according to claim 6, wherein
the shielding device comprises a shielding layer of a shielding material showing electric superconductivity at the operation temperature.

9. The conductor device according to claim 1, further comprising
a cable interface termination being arranged at at least one end of the conductor device and comprising a solid carrier substrate supporting the conductor wires at the cable interface termination, wherein the longitudinal end sections of the conductor wires at the cable interface termination are exposed at a same end.

10. The conductor device according to claim 9, wherein
the carrier substrate has a lateral extension larger than a width of the electrically insulating encapsulation material encapsulating the conductor wires, and the solid carrier substrate has an indentation in a lateral direction thereof.

11. The conductor device according to claim 1, wherein
the conductor wires comprise at least one of NbTi and Nb₃Sn,
the electrically insulating encapsulation material comprises a polyimide-based material or a polymer that does not comprise the polyimide-based material, and
at least 4 conductor wires are included in the conductor device.

12. An electrical conductor arrangement, comprising
a first electrical device and a second electrical device, and
the conductor device according to claim 1, being electrically connected between the first and second electrical devices.

13. A method of manufacturing the conductor device according to claim 1, comprising the steps of:
providing the conductor wires, and
encapsulating the conductor wires in the electrically insulating encapsulation material by extrusion with an extruder apparatus.

14. The method according to claim 13, wherein
the step of providing the conductor wires comprises arranging the conductor wires in parallel and side-by-side so that the conductor device is extruded with a flat cable shape.

15. The method according to claim 13, further comprising
flattening at least one longitudinal end section of at least one of the conductor wires.
